(19) United States
(12) Patent Application Publication
(10) Pub. No.: US 2020/0190859 A1
(43) Pub. Date: Jun. 18, 2020

(54) ELECTRONIC LOCKING DEVICE

(71) Applicant: Henry Squire & Sons Holdings Ltd, Wolverhampton (GB)

(72) Inventor: Glyn Green, Wolverhampton (GB)

(21) Appl. No.: 16/716,849

(22) Filed: Dec. 17, 2019

(30) Foreign Application Priority Data
Dec. 18, 2018 (GB) 1820604.5

(51) Int. Cl. E05B 47/06; E05B 47/00

(52) U.S. Cl. CPC E05B 47/0619; E05B 2047/0092; E05B 47/0038; E05B 47/0002

(57) ABSTRACT

An electromagnetic locking device is disclosed including a barrel and a plug which are able to move relative to one another when in an unlocked condition. A locking mechanism, within the locking device, includes a pair of shuttles which include permanent magnets which are caused to move in opposite directions by an electromagnet to push the shuttles into respective recesses so as to not straddle the junction between the plug and barrel. Also forming part of the locking device are one or more jammer mechanisms which include ferromagnetic jammers which are drawn into recesses when under the influence of external magnets. If a strong external magnet is used to draw the shuttles into the recesses therefore not straddling the recesses, the jammers are drawn into the recesses and straddle that junction thereby maintaining the locked condition.

### CROSS-REFERENCE TO RELATED PATENT APPLICATIONS

The present application claims priority to United Kingdom Patent Application No. 1820604.5, filed Dec. 18, 2018. The disclosure of the aforementioned priority application is incorporated herein by reference in its entirety.

The present invention relates to an electronic locking device and relates particularly, but not exclusively, to an electronic locking device used on a door.

Electronic locking devices are commonly used to control entry through doors either using electronic keys or entry keypads and are being increasingly used on other locking devices such as padlocks and bike locks. An example of such a locking device is disclosed in our earlier application published under the number EP1331328. This document describes the use of an electromagnet to move a pair of shuttles in opposite directions. When the electromagnet is not receiving power, the shuttles straddle the junction between the rotatable and fixed parts of the lock thereby preventing movement of the rotatable part. When the electromagnet is receiving power the shuttles, which are formed from permanent magnets, move in opposite directions away from the electromagnet into recesses in the fixed portion of the lock thereby allowing the rotatable part of the lock to move.

Because the shuttles are formed from permanent magnets they can be moved using extremely powerful magnets. Normally, because these shuttles are adapted to move in opposite directions the use of a powerful magnet will move the shuttles in the same direction. Although this potentially moves one of the shuttles out of the locked condition it maintains the other in the locked condition thereby preventing the lock from being opened. However, sometimes a position can be found with a particular strength of magnet which causes both shuttles to move into the unlocked condition allowing the lock to be opened.

Preferred embodiments of the present invention seek to overcome or alleviate the above described disadvantages of the prior art.

According to an aspect of the present invention there is provided an electromagnetic locking device comprising:
first and second body portions located adjacent one another and having a junction therebetween, said locking device providing said body portions with an unlocked condition in which said body portions are moveable relative to one another and with a locked condition in which said body portions are not moveable relative to one another;
a locking mechanism comprising at least one first shuttle and at least one electromagnet fixed to one of said first and second body portions and associated with said first shuttle such that when said electromagnet is in a dormant condition said first shuttle straddles the junction between said first and second body portions so as to prevent movement of said first and second body portions relative to one another and such that when said electromagnet is energised said shuttle moves and does not straddle said junction thereby allowing movement of said first and second body portions;
a jammer mechanism comprising at least one jammer comprising at least one ferromagnetic material said jammer adapted to move between a first jammer condition in which said jammer straddles the junction between said first and second body portions thereby preventing movement of said first body portion relative to said second body portion and a second jammer condition in which said jammer does not straddle the junction between said first and second body portions thereby allowing movement of said first body portion relative to said second body portion wherein the or each jammer tends towards said second jammer condition.

Providing a combination of locking mechanism, as set out above, and a jammer mechanism offers significant advantages over the prior art. In particular, where the jammer mechanism includes ferromagnetic materials aligned to act in the opposite direction to the shuttles of the locking mechanism, the advantage is provided that if a magnet is introduced near to the locking mechanism and manages to move the shuttles in opposite directions the jammers will, at the same time, be drawn into positions where they straddle the junction between the first and second body portions thereby maintaining the locked condition. This maintenance of the locked condition is achieved most effectively where multiple jammers are used in different locations (that is where the movement of the jammers are on parallel axes) and also in different orientations (that is where the movement of the jammers are on axes which are not parallel to one another).

In a preferred embodiment the first body portion is a plug and said second body portion is a barrel.

In another preferred embodiment the electromagnet is contained within said first body portion.

In a further preferred embodiment the locking mechanism further comprises at least one first recess, wherein said first shuttle can be received within said first recess.

The locking mechanism may further comprise at least one second recess, wherein said first shuttle can only be partially received within said second recess.

The jammer mechanism may further comprise at least one third recess, wherein said first jammer can be received within said third recess.

The jammer mechanism may alternatively comprise at least one fourth recess, wherein said first shuttle can only be partially received within said fourth recess.

In a preferred embodiment the first jammer comprises a permanent magnet.

In another preferred embodiment the jammer mechanism further comprises a core of a non-magnetised ferromagnetic material.

In a further preferred embodiment the first shuttle comprises a non-magnetised ferromagnetic material.

The jammer mechanism may further comprise a second jammer

In a preferred embodiment the first and second jammers are aligned to move coaxially.

In another preferred embodiment the locking mechanism further comprises a second shuttle.

In a further preferred embodiment the first and second shuttles are aligned to move coaxially.

In a preferred embodiment the movement of said jammers and said shuttles are not coaxial.

The locking device may further comprise multiple jammer mechanisms.

In a preferred embodiment the jammers in the multiple jammer mechanisms move on parallel axes.

Preferred embodiments of the present invention will now be described, by way of example only, and not in any limitative sense with reference to the accompanying drawings in which:

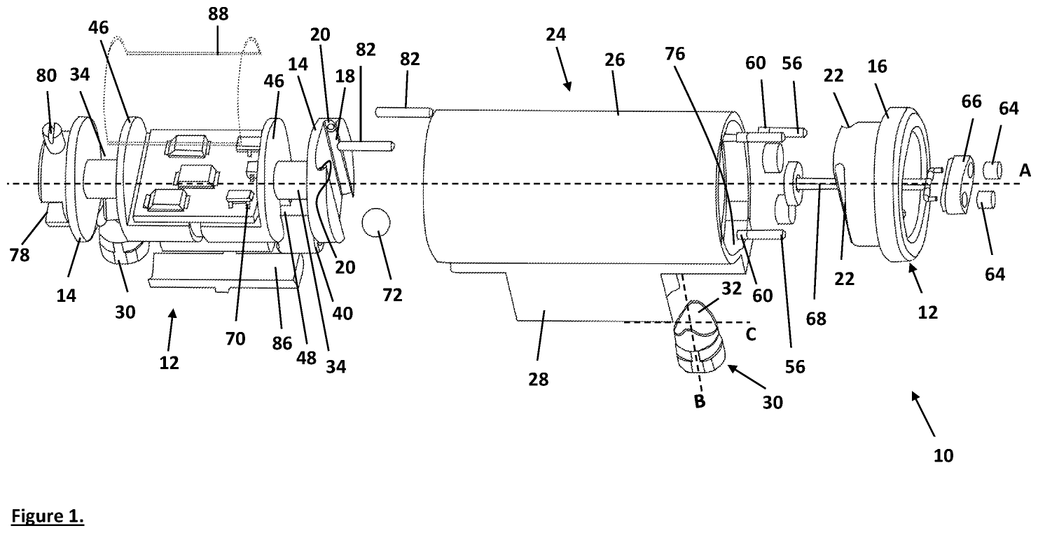

FIG. 1 is an exploded view of a first embodiment of an electronic locking device of the present invention;

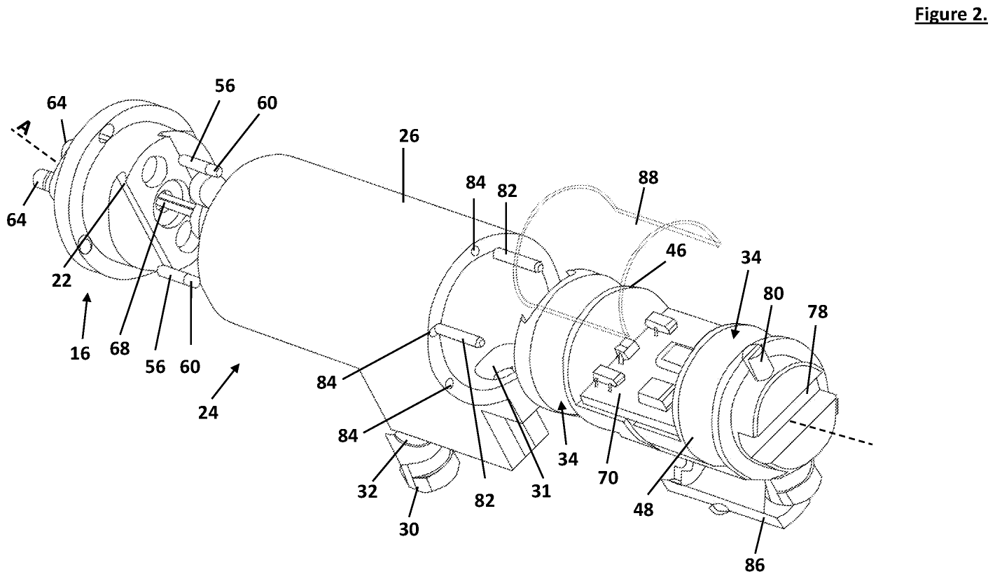

FIG. 2 is an alternative exploded view from a different angle of the device of FIG. 1;

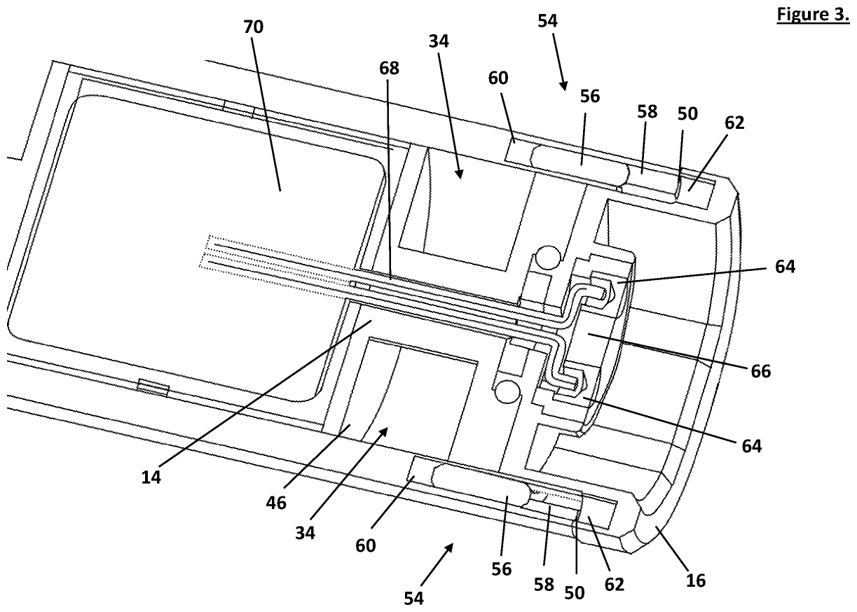

FIG. 3 is a sectional view of a portion of the device of FIG. 1 in an assembled condition;

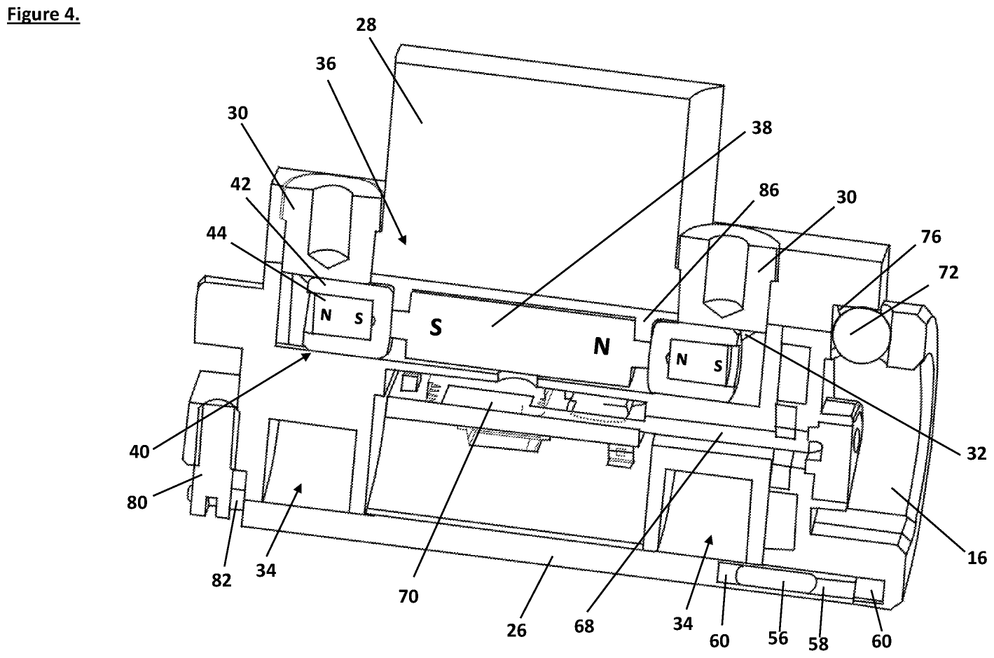

FIG. 4 is a sectional view of the device of FIG. 1 in an assembled condition; and

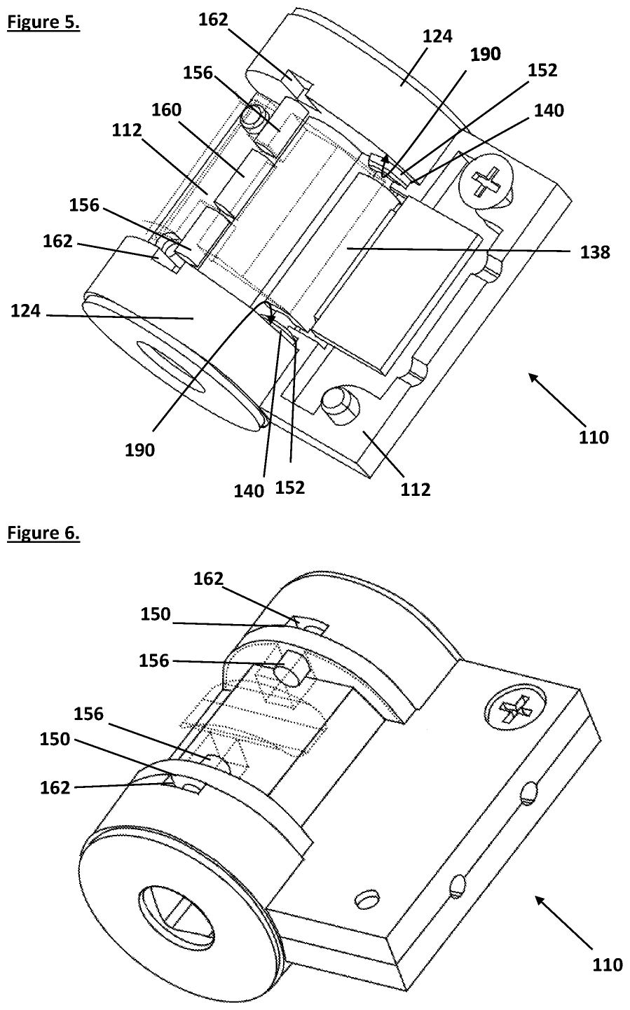

FIGS. 5 and 6 are views of a second embodiment of the present invention.

Referring to FIGS. 1 to 4, and electronic locking device 10 is provided in the shape commonly referred to as a key in knob (KIK) cylinder. The locking device 10 includes a first body portion in the form of a plug 12 which is formed from a main plug portion 14 and an end cap 16 which are joined together using metal dowels 18 which slot into semi-circular channels 20 and 22 formed in the main plug portion and end cap respectively. A second body portion, in the form of barrel 24, is also provided and, although formed as a single component includes a cylindrical portion 26 and an extension 28 which together form the external surfaces that are familiar in the shape of a KIK cylinder. Also forming part of the barrel are a pair of inserts 30 which extend from the extension portion into the internal volume of the cylinder portion 26. The inserts 30 are most clearly shown in FIG. 1 and their shape is substantially cylindrical with the axis of that cylinder B being perpendicular to the axis A of the cylindrical portion 26 of barrel 24 when they are located into an aperture 31 in the barrel 24. Formed into the cylinder of insert 30 is a cylindrical cutaway having approximately the same diameter as the cylinder of the insert 30 but its axis C being perpendicular to the axis be and, in use, parallel with the axis A thereby forming a curved surface 32.

The main plug portion 14 is typically machined from a piece of cylindrical metal and has a pair of annular channels 34 formed therein. When the plug 12 is inserted into the barrel 24 the annular channels 34 are aligned with the inserts 30 and enable the plug 12 to rotate despite the inserts 30. In particular the curved surfaces 32, extend into the internal volume defined by the cylindrical portion 26 of barrel 24.

The electromagnetic locking device 10 also includes a locking mechanism which comprises an electromagnet 36 fixed to the main plug portion 14 and located between the annular channels 34. Also forming part of the locking mechanism 36 are a pair of shuttles 40 which are formed from an outer casing 42 of a non-ferromagnetic material such as brass and a shuttle core 44 which is formed from a permanent magnet. The arrangements of the poles of the magnets 44 in the shuttles and the electromagnet 38 are shown, by way of example, in FIG. 4. As can be seen the magnets are arranged so that the north pole of the electromagnet 38 as the north pole of its respective shuttle core 44 closest to it and likewise the south pole of the electromagnet has the south pole of its shuttle core closest to it. As a result, when the electromagnet 38 is receiving power and producing a magnetic field the cores 44, and therefore shuttles 40, are repelled away from the electromagnet. However, when no power is being provided to the electromagnet 38 the non-magnetised ferromagnetic core of the electromagnet causes the magnetic cores 44 of shuttles 40 to be attracted towards the electromagnet. It should be noted that the inner walls 46 which define the channels 34 in main plug portion 14 have apertures 48 formed therein which are sized to receive the shuttles 40. These cylindrical shuttles 40 also are sized to match the curved surface 32 of the insert 30.

The electromagnetic locking device operates between two conditions, those being an unlocked condition where the plug 12 is able to move (specifically rotate) relative to the barrel 24 and a locked condition where the plug is unable to rotate within the barrel. Because the plug 12 fits closely into the barrel 24 there is a junction, or more accurately multiple junctions, where the plug 12 has surfaces which are in contact with, or very close to being in contact with adjacent surfaces of the barrel 24. Two significant examples of these junctions include, as indicated at 50, the junction between the end surface of the cylindrical portion 26 of barrel 24 and the end cap 16 and also, as indicated at 52, where the insert 30 is immediately adjacent the aperture 48 in wall 46 of the annular channel 34 of main plug portion 14. It is at these points of the junction between the plug 12 and barrel 24 that it is determined whether the device 10 is locked, because the plug and barrel cannot move or is unlocked because the plug is able to rotate within the barrel.

Where no other outside interference is taking place, it is the locking mechanism, specifically the position of the shuttles 40, which determines whether the electromagnetic locking device 10 is in a locked or an unlocked condition. When no power is being directed to the electromagnet 38 the shuttles 40 are in the condition shown in FIG. 4, that is the magnetic cores 44 of the shuttles 40 are attracted towards the ferromagnetic core of the electromagnet 38. As a result, the shuttles 40 are partially located within the inserts 30, engaging the curved surface 32 and also extend through the apertures 48 in wall 46 of the main plug portion 14. The shuttle 40 therefore straddles the junction 52 between the plug 12 and barrel 24. Thus, any attempt to rotate the plug 12 causes the edge of the aperture 48 to press against the shuttle 40 in an attempt to move the shuttles 40 with the apertures 48. However, because the insert 30 is fixed to the barrel 24 and because the shuttle 40 fits closely into the curved surface 32 of the insert, the shuttle cannot follow the path of the aperture 48 and therefore the edge of the aperture jams against the shuttle preventing the rotation of the plug 12 in the barrel 24. As a result, the device 10 is in a locked condition.

If power is supplied to the electromagnet 38 the shuttles 40 move away from the electromagnet and are contained within the annular channels 34 (the length of the shuttles 40 being approximately the same as the width of the annular channel). The shuttles 40 therefore no longer straddle the junction 52 and do not extend through the aperture 48. As a result, the plug 12 is able to rotate within the barrel 24 and the device 10 is in an unlocked condition.

In addition to the locking mechanism 36 there is provided a jammer mechanism 54 which protects the electromagnetic locking device against attempts to move the shuttles 40 using an external magnetic force without activating the electromagnet 38. The jammer mechanism comprises one or more jammers 56 which are formed from a ferromagnetic material such as mild steel and therefore move under the influence of a magnet. The jammer 56 is located in a recess 58 formed in the end of the cylindrical portion 26 of barrel 24. The jammer 56 is substantially cylindrical in its shape and this shape matches the recess 58. At the closed end of recess 58 a permanent magnet 60 is fixed which attracts the ferromagnetic jammer 56 towards it. The recess 58 is sized to entirely contain the magnet 60 and jammer 56. A further recess 62 is formed in the end cap 16 such that when the device 10 is in a locked condition the recesses 58 and 62 are aligned. The recess 62 is much shorter than the recess 58 and can only partially receive the jammer 56.

If a magnet is introduced to the lock on the outside of end cap 16 and if the magnetic force from this magnet is greater than that of the small magnet 60 in recess 58 then the jammer 56 will be drawn towards and into recess 62. In this condition the jammer 56 is straddling the junction 50 between the barrel 24 and the end cap 16 of plug 12 thereby preventing rotation of the plug relative to the barrel. In contrast, if no such magnetic force is applied, the jammer 56 is drawn towards the magnet 60 and does not straddle the junction 50 thereby allowing rotation of the plug 12 relative to the barrel 24. As a result, if a magnet of sufficient strength is introduced adjacent to the end cap 16 to draw one of the shuttles 40 towards it and to cause the other shuttle 40 to be repelled, the jammer 56 would also be drawn towards that magnet maintaining the locked condition of the device 10.

As can be seen in other figures multiple jammer mechanisms can be provided to enhance this function. For example, as shown in FIGS. 1 and 3, jammers 56 are provided around different locations on the circumference of cylindrical portion 26 of barrel 24. These examples all show the movement of the jammers to be along axes which are parallel to each other and parallel to the axis A. It is also possible to include jammer mechanisms which operate in axes which are transverse to each other. For example, although not shown in the drawings, a recess of the type labelled 58 could be provided in the extension 28 of barrel 24 and, under the influence of an external magnet, the drawn into a short recess of type 62 in the body of main plug portion 14. However, it would be necessary to ensure that the powering of the electromagnet 38, which is contained within the main plug portion 14, does not draw that jammer into the recess. Having more jammer mechanisms and jammer mechanisms at angles which are transverse to each other makes it increasingly difficult to locate a powerful magnet on the exterior of the locking device 10 so as to move both the shuttles 40 into the annular channels 34, a condition which allows rotation of the plug 12 without also drawing the jammers 56 into the recesses 62.

Because the locking device 10 is an electronic locking device an electrically powered key (not shown) is used to activate the device. The key engages a pair of contacts 64 which are located in the end cap 16 in a housing 66 into which a pair of cables 68 extend and transfer power and a key code to a processor in the form of integrated circuits mounted on a circuit board 70. In order to ensure that the key cannot be accidentally removed during rotation of the plug 12, a locking bearing 72 is provided in an aperture 74 in the end cap 16. When the device 10 is in a locked condition the aperture 74 and locking bearing 72 are aligned with a recess or indentation 76 in the inner circumference of the end of the cylindrical portion 26 of barrel 24 where it engages the end cap 16. This allows the bearing to be pushed up radially outwards to allow the key to access the end cap. Once the key begins to rotate the end cap, the locking bearing 72 is no longer in the indentation 78 and pushes slightly through the apertures 74 and into a corresponding indentation in the key thereby locking the key in position until the key rotates back to the original position with the locking bearing 72 aligned with the indentation 76.

The end of the main plug portion which is furthest away from the end cap 16 includes a drive slot 78 which engages whatever part of the door or other locked device is to be controlled by the locking device 10, for example the latch to the door. Adjacent the drive slot 78 is a grub screw 80 which works along with dowel rods 82 to limit the rotation of the plug 12 within the barrel 24. As can be seen in FIG. 2 the end of the cylindrical portion 26 of barrel 24 is provided with further recesses 84 into which a pair of metal dowel rods 82 are located. The recesses 84 are shorter than the length of the dowel rods 82 resulting in the dowel rods extending beyond the end of the cylindrical portion 26 of barrel 24 as seen in FIG. 4. Rotation of the plug 12 causes the grub screw 82 contact the ends of the dowel rods 82 which extend out from the recesses 84 thereby limiting the rotation of the plug 12. As can be seen in FIG. 2 multiple recesses 84 have been provided in order to vary the amount of rotation that the plug 12 can undertake depending upon the situation that the locking device 10 is being used.

As can be seen in FIGS. 1 and 4, a retaining cover 86 is provided to correctly locate and fix the electromagnet 38 in position within the main plug portion 14. A plastic dust cover 88 is also provided to protect the circuit board 70 and components thereon although this can be replaced with other protective coatings on the circuit board.

Referring to FIGS. 5 and 6, these figures show an alternative embodiment of the invention in which like components have been given the same reference numerals as the previous embodiment increased by 100. In this locking device 110 the electromagnet 138 repels the shuttles 140 into recesses 190 in the second body portion 124. When no power is being provided to the electromagnet 138, as shown in the condition in FIG. 5, the first body portion 112 and second body portion 124 cannot rotate relative to one another because the shuttles straddle the junction 152 between the first and second body portions 112 and 124. Once power is supplied to the electromagnet 138 the shuttles are pushed into the recesses 190 and therefore no longer straddle the junctions 152 thereby allowing the first and second body portions 112 and 124 to rotate relative to one another.

If powerful magnets are placed either side of the device 110 the shuttles 140 can be pulled into the recesses 190. However, the device 110 is provided with a pair of jammers 156 which can be partially received into recesses 162. In the condition shown in FIG. 5 the jammers are not contained at all within the recesses 162, do not straddle the junction 150 and therefore do not prevent rotation of the first and second body portion 112 and 124 relative to one another. Under the circumstances, as previously described, where magnets are introduced to either side of the locking device 110, the jammers 156 are pulled in opposite directions and partially extend into the recesses 162, as shown in FIG. 6. In this condition the jammers 156 are straddling the junction 150 between the first and second body portions 112 and 124 and therefore prevent the rotation of the first and second body portions 112 and 124. In this embodiment a single permanent magnet 160 is provided to ensure that, under normal circumstances, the jammers, being formed from mild steel or some other ferromagnetic material, are drawn away from the recesses 162 thereby only preventing the rotation of the first and second body portions relative to one another in the event that strong magnets are introduced to either side of the locking device 110.

It will be appreciated by persons skilled in the art that the above embodiments have been described by way of example only and not in any limitative sense, and that various alterations and modifications are possible without departure from the scope of the protection which is defined by the appended claims. For example, the jammers 56 and 156 could be formed from permanent magnets rather than from mild steel. In the example the first embodiment where multiple jammers are provided these jammers would preferably be arranged with their poles in different directions and the magnet 60 would be replaced with a ferromagnetic material such as mild steel to attract the magnet entirely within the recess 58. In the second embodiment if the jammers 156 are magnetised and arranged such that their opposing poles are arranged adjacent one another, the magnet 160 can be replaced with a core of ferromagnetic material or even be removed entirely since the magnets would be attracted towards one another as long as some material was present to prevent the magnets from completely engaging one another.

In the embodiments set out above the electromagnet is located centrally and repels a pair of shuttles including permanent magnets. The apparatus can operate using a single shuttle and the use of jammers is particularly useful under the circumstances since single shuttle devices are more vulnerable to attack from external magnets. As another alternative, the shuttles could be formed from non-magnetised ferromagnetic material which is attracted towards a permanent magnet in the recess to ensure that the shuttle straddles the junction between the first and second body portions when in the locked condition. It is also possible to swap the arrangement of the magnet and shuttles so that the shuttle is attracted to a small permanent magnet in a shorter recess 190 and therefore always straddles the junction 152 until it is drawn towards the electromagnet 138, which is smaller in size than that shown in FIG. 5 thereby ensuring that the shuttle 140 is pulled completely from within the recess 190. In order for this to work the electromagnet 138 must be powerful enough to overcome the force of the permanent magnet contained within the end of recess 190 and that magnet must be strong enough to attract the shuttle back into the recess once the electromagnet 138 is been switched off. These arrangements of electromagnetic lock can also work with keypad controllers as well as with combined manual and electronic keys. The first embodiment is an example of the invention being used in relation to a KIK cylinder. However, it will be clear to persons skilled in the art that the invention can be equally used with other forms of cylinder including, but not limited to, a Euro-cylinder, Oval, Interchangeable Core and Mortise Profile.

1. An electromagnetic locking device comprising:
first and second body portions located adjacent one another and having a junction therebetween, said locking device providing said body portions with an unlocked condition in which said body portions are moveable relative to one another and with a locked condition in which said body portions are not moveable relative to one another;
a locking mechanism comprising at least one first shuttle and at least one electromagnet fixed to one of said first and second body portions and associated with said first shuttle such that when said electromagnet is in a dormant condition said first shuttle straddles the junction between said first and second body portions so as to prevent movement of said first and second body portions relative to one another and such that when said electromagnet is energised said shuttle moves and does not straddle said junction thereby allowing movement of said first and second body portions;
a jammer mechanism comprising at least one jammer comprising at least one ferromagnetic material said jammer adapted to move between a first jammer condition in which said jammer straddles the junction between said first and second body portions thereby preventing movement of said first body portion relative to said second body portion and a second jammer condition in which said jammer does not straddle the junction between said first and second body portions thereby allowing movement of said first body portion relative to said second body portion wherein the or each jammer tends towards said second jammer condition.

2. A locking device according to claim 1, wherein said first body portion is a plug and said second body portion is a barrel.

3. A locking device according to claim 1, wherein said electromagnet is contained within said first body portion.

4. A locking device according to claim 1, wherein said locking mechanism further comprises at least one first recess, wherein said first shuttle can be received within said first recess.

5. A locking device according to claim 1, wherein said locking mechanism further comprises at least one second recess, wherein said first shuttle can only be partially received within said second recess.

6. A locking device according to claim 1, wherein said jammer mechanism further comprises at least one third recess, wherein said first jammer can be received within said third recess.

7. A locking device according to claim 1, wherein said jammer mechanism further comprises at least one fourth recess, wherein said first shuttle can only be partially received within said fourth recess.

8. A locking device according to claim 1, wherein said first jammer comprises a permanent magnet.

9. A locking device according to claim 1, wherein said jammer mechanism further comprises a core of a non-magnetised ferromagnetic material.

10. A locking device according to claim 1, wherein said first shuttle comprises a non-magnetised ferromagnetic material.

11. A locking device according to claim 1, wherein said jammer mechanism further comprises a second jammer

12. A locking device according to claim 1, wherein said first and second jammers are aligned to move coaxially.

13. A locking device according to claim 1, wherein said locking mechanism further comprises a second shuttle.

14. A locking device according to claim 1, wherein said first and second shuttles are aligned to move coaxially.

15. A locking device according to claim 1, wherein said movement of said jammers and said shuttles are not coaxial.

16. A locking device according to claim 1, further comprising multiple jammer mechanisms.

17. A locking device according to claim 16, wherein said jammers in said multiple jammer mechanisms move on parallel axes.
